(19) United States
(12) Patent Application Publication
(10) Pub. No.: US 2018/0073941 A1
(43) Pub. Date: Mar. 15, 2018

(54) ARRANGEMENT AND METHOD FOR CONTACTLESS MEASUREMENT OF A TORQUE ON A MACHINE ELEMENT

(71) Applicant: SCHAEFFLER TECHNOLOGIES AG & CO. KG, Herzogenaurach (DE)

(72) Inventors: Christian MOCK, Schweinfurt (DE); Florian KOENIGER, Schweinfurt (DE)

(73) Assignee: SCHAEFFLER TECHNOLOGIES AG & CO. KG, Herzogenaurach (DE)

(21) Appl. No.: 15/565,264

(22) PCT Filed: Mar. 29, 2016
(86) PCT No.: PCT/DE2016/200162

§ 371 Date: Oct. 9, 2017

(30) Foreign Application Priority Data
Apr. 7, 2015 (DE) 10 2015 206 152.3

(51) Int. Cl. G01L 1/12; G01L 3/10

(52) U.S. Cl. CPC G01L 1/122; G01L 3/104; G01L 3/102; G01L 1/125

(57) ABSTRACT

An apparatus for contactless measurement of torque, comprising a machine element that includes a magnetization section located at least within an axial section of the machine element, and one or more magnetic field sensors configured to measure an axial directional component of a magnetic field from the permanent magnetization and the torque, or a change of the axial directional component of the magnetic field from the permanent magnetization and the torque.

### CROSS-REFERENCE TO RELATED APPLICATIONS

This application is the U.S. National Phase of PCT/DE2016/200162 filed Mar. 29, 2016, which claims priority to DE 102015206152.3 filed Apr. 7, 2015, the entire disclosures of which are incorporated by reference herein.

### TECHNICAL FIELD

The disclosure relates to an arrangement and a method for contactless measurement of a torque on a machine element which extends in one axis with utilization of the inverse magnetostrictive effect. In particular, the disclosure also permits the measurement of a rotational angle and/or of a rotational speed of the machine element.

### BACKGROUND

DE 602 00 499 T2 shows a position sensor for detecting the torsion of a steering column. The position sensor consists of a first magnetic structure with a plurality of magnets and of a second magnetic structure with two ferromagnetic rims. The two ferromagnetic rims engage and define an air gap in which at least one magnet-sensitive element is arranged.

EP 0 706 057 A2 relates to a magnetic image sensor which uses the Matteucci effect. The image sensor comprises a magnetic wire and a means for circumferential magnetization of the wire.

An annular magnetized torque sensor is known from DE 692 22 588 T2.

A magneto-elastic torque sensor with annular magnetization is known from DE 698 38 904 T2. The magnetization is configured in a ferromagnetic, magnetostrictive material of a shaft and extends in a circle around the shaft.

WO 2007/048143 teaches a sensor with a magnetized shaft. The magnetization is configured revolving around the shaft, wherein the magnetization can be inclined towards the axis.

WO 01/27638 A1 shows an acceleration sensor with a shaft that is circumferentially or longitudinally magnetized.

A torque sensor is known from WO 2006/053244 A2 comprising a magnetization on a rotating shaft. The magnetization is configured circumferentially.

U.S. Pat. No. 8,191,431 teaches a sensor comprising a magnetized shaft and a magnetic sensor. The sensor permits the measurement of a torque and also the measurement of a rotational speed or of a rotational angle of the shaft. The magnetization is configured revolving around the shaft, wherein the magnetization can be inclined towards the axis.

DE 601 09 715 T2 shows a magnetostrictive torque measurement sensor with a shaft made of a magnetostrictive material which is magnetized by opposing permanent magnets. A power flow detector is used to measure the magnetic field emerging from the rotating shaft due to the magnetostrictive effect. The permanent magnets arranged opposite one another lead to a diametrically expanding magnetic field in the shaft.

### SUMMARY

Proceeding from the prior art, the present disclosure addresses the problem of expanding the possibilities of a measurement of torques based on the inverse magnetostrictive effect.

The mentioned problem may be solved according to the various embodiments disclosed herein.

The disclosure may be used for contactless measurement of a torque on a machine element which extends in an axis. The torque acts on the machine element, as a result of which mechanical stresses arise and the machine element usually deforms slightly. The axis may form a rotational axis of the machine element. The torque may bea torsional moment.

The machine element has a permanent magnetization which is configured at least within an axial section of the machine element. The permanent magnetization may be configured completely in this axial section of the machine element. Correspondingly, the machine element may be made of a ferromagnetic material at least in the axial section.

The permanent magnetization has two magnetic poles, i.e. a north pole and a south pole, which lie diametrically opposite one another in relation to the axis. Therefore this permanent magnetization is oriented parallel to a straight line, which may be oriented radially in relation to the axis. This straight line intersects the axis at a right angle. This straight line comprises a diameter of the machine element, namely the diameter which connects the two magnetic poles of the permanent magnetization. The orientation of the permanent magnetization can also be described as diametrical in relation to the machine element and its axis. Also, the orientation of the permanent magnetization can alternatively be described by the fact that the permanent magnetization runs parallel to a connecting straight line on both sides which connects two opposite points at a 180° distance of the diameter. The permanent magnetization may have precisely two of the magnetic poles. The permanent magnetization may be oriented completely parallel to the mentioned straight line, which is oriented radially in relation to the axis.

Due to the torque acting on the machine element, on the basis of the magnetoelastic method there is a reversible change of the previously impressed permanent magnetization, which can be verified by measuring the magnetic fields outside of the machine element.

The described orientation of the permanent magnetization is given by the progression of the magnetic field lines of the permanent magnetization. The magnetic field lines hence run parallel on both sides to a connecting straight line, which connects two opposite points at a 180° distance of the diameter. The magnetic field lines of the permanent magnetization close outside of the machine element along curved paths. Within the machine element the magnetic field lines of the permanent magnetization run parallel to one another. Alternatively, the permanent magnetization can also be impressed only within the machine element, so that outside of the machine element no magnetic field lines are present.

The machine element with the permanent magnetization forms a primary sensor for measuring the torque. In the case of torsional load the resulting shear stress brings about a torsion of the permanent magnetization due to the inverse-magnetostrictive effect and the resulting magnetoelastic coupling. At the places where the magnetic field lines of the permanent magnetization run tangentially to the surface, an axial magnetic field component arises. On the other hand, if the magnetic field lines of the permanent magnetization run perpendicular to the surface, no magnetic field component arises.

Furthermore, the arrangement comprises at least one magnetic field sensor which forms a secondary sensor. The primary sensor, i.e. the machine element e.g. in the form of a shaft with the permanent magnetization serves the purpose of converting the torque to be measured into a corresponding magnetic field or to a magnetic field change, while the secondary sensor enables the conversion of this magnetic field or of this magnetic field change into an electrical signal. The magnetic field sensor is configured for the individual measurement of an axial directional component of a magnetic field brought about by the permanent magnetization as well as by the torque or of an axial directional component of a magnetic field change brought about by the permanent magnetization as well as by the torque. The mentioned magnetic field or the mentioned magnetic field change occurs on the basis of the inverse magnetostrictive effect. Hence, the measurement made possible with the inventive arrangement is based on the inverse magnetostrictive effect. The axial directional component of the mentioned magnetic field or of the mentioned magnetic field change is also dependent on the rotational angle of the machine element, so that said component for example periodically changes when the machine element rotates and the torque is constant. Accordingly, the magnetic field sensor may be configured for measuring an amplitude and/or a phase location of the axial directional component of the magnetic field brought about by the permanent magnetization as well as by the torque or by the axial directional component of the magnetic field change brought about by the permanent magnetization as well as by the torque. The machine element may be subjected exclusively to a torsional moment, which together with the permanent magnetization may be brought about exclusively by the axial directional component of the mentioned magnetic field or of the mentioned magnetic field change.

The magnetic field sensor is arranged opposite the machine element, wherein only a slight radial distance may be present between the magnetic field sensor and an inner or outer surface of the machine element.

The magnetic field sensor may be located in the mentioned axial section of the machine element in which the permanent magnetization is located.

One advantage of the disclosure includes the fact that the permanent magnetization of the machine element is also verifiable without load by a torque from the outside or inside and already offers the possibility of rotational speed and/or rotational angle measurement. This simple verifiability of the permanent magnetization is also advantageous for production from the perspective of quality assurance.

The specified radial direction, the specified axial direction and the specified tangential direction in principle relate to the axis of the machine element. These three directions are oriented perpendicular to one another.

The permanent magnetization is configured in at least a part of the volume of the machine element. This part of the volume may be configured annular, wherein the axis of the machine element also forms a central axis of the ring form. Particularly, this part of the volume may have the shape of a hollow cylinder coaxial to the axis of the machine element.

The machine element may form a component of the illustrative embodiment disclosed herein.

Furthermore, this may serve the purpose of measuring a rotational angle and/or a rotational speed of the machine element, for which the magnetic field sensor is configured for measuring a rotational angle-dependent change of the magnetic field of the permanent magnetization. It is namely a special advantage of the orientation of the permanent magnetization that it permits simultaneous measurement of torques as well as of rotational speed and/or rotational angle.

In the case of these embodiments, the magnetic field sensor may be configured for individual measurement of a radial directional component or of a tangential directional component of the magnetic field of the permanent magnetization. Through measurement of a single one of these two directional components at least the rotational speed or the rotational angle can be determined in a fraction of the full angle. If the rotational angle is supposed to be determinable over the entire full angle, the magnetic field sensor may be configured for individual measurement of two directional components of the magnetic field of the permanent magnetization aligned perpendicular to one another. In the course of this, the magnetic sensor may be configured for individual measurement of the radial directional components of the magnetic field of the permanent magnetization and for individual measurement of the tangential directional components of the magnetic field of the permanent magnetization. The radial directional components and the tangential directional components have a phase offset of 90° to one another in the event of a rotation of a machine element, so that the rotational angle can be clearly determined over the entire full angle.

The at least one magnetic field sensor may be formed by a multiple axis magnetic field sensor which makes possible the measurement of the different directional components of the mentioned magnetic fields, which may be three directional components perpendicular to one another. The multiple axis magnetic field sensor may be configured for individual measurement of the axial directional component, for individual measurement of the radial directional component and for individual measurement of the tangential directional component.

However, the at least one magnetic field sensor can also comprise several magnetic field sensor elements which make possible the measurement of the different directional components of the magnetic fields. The several magnetic field sensor elements can be arranged within a housing; however they can also be arranged separately from one another.

At least one magnetic field sensor can be arranged outside of the machine element or also within a hollow space of the machine element; for example if the machine element is formed by a hollow shaft.

The diametrical permanent magnetization can be developed in a variety of ways. The magnetic field lines of the permanent magnetization may be measurable both outside of the machine element as well as also within the hollow space of the machine element, which is the case both in a loaded state of the machine element as well as also in an unloaded state of the machine element. Alternatively, the magnetic field lines of the permanent magnetization may be measurable exclusively within the hollow space of the machine element, which is the case both in a loaded state of the machine element as well as also in an unloaded state of the machine element.

The machine element may have a high magnetostrictivity at least in the region of its permanent magnetization. In this respect the machine element consists at least in the region of its permanent magnetization of a magnetostrictive material.

The machine element may have the shape of a cylinder, wherein the cylinder is arranged coaxially to the axis. The cylinder may be straight. The machine element may have the shape of a right circular cylinder, wherein the circular cylinder is arranged coaxially to the axis. In the case of special embodiments, the cylinder is conically configured. The cylinder can also be hollow.

The machine element may be formed by a shaft, by a hollow shaft, by a shifting fork, by a flange or by a hollow flange. The shaft, the hollow shaft, the shifting fork, the flange or the hollow flange can be designed for loads by various forces and torques and for example can be a component of a sensor bottom bracket bearing, an active roll stabilizer or of a broadcast spreader. In principle, the machine element can also be formed by completely different machine element types.

The at least one magnetic field sensor or its magnetic field sensor elements may be formed by a semiconductor sensor, e.g. by a Hall effect or xMR sensor or by a coil, e.g. by a fluxgate magnetometer. In principle, other sensor types can also be used, provided they are suitable for measurement of an individual or of several individual directional components of the magnetic field or the magnetic fields.

The illustrative method may allow contactless measurement of a torque on a machine element which extends in one axis. The machine element may have a permanent magnetization which is configured at least within an axial section of the machine element and is oriented parallel to a radially oriented straight line. A measurement may occur of an axial directional component of a magnetic field brought about by the permanent magnetization as well as by the torque or of an axial directional component of magnetic field change brought about by the permanent magnetization as well as by the torque. In one embodiment, an amplitude and/or a phase of the axial directional component of the magnetic field brought about by the permanent magnetization as well as by the torque or of the axial directional component of the magnetic field change brought about by the permanent magnetization as well as by the torque are measured in order to determine the torque.

Furthermore, the method may allow measurement of a rotational angle and/or of a rotational speed of the machine element, for which a rotational angle-dependent change of the magnetic field of the permanent magnetization is measured.

The various embodiments may be used to carry out the disclosed method. The disclosed method may have such features that are explained in the various embodiments disclosed herein.

### BRIEF DESCRIPTION OF THE DRAWINGS

Additional details, advantages and improvements of the disclosure arise from the subsequent description of the various embodiments with reference to the drawings. The figures show the following:

FIG. 1 shows a hollow shaft of an embodiment in two views;

FIG. 2 shows magnetic field lines in the hollow shaft shown in FIG. 1;

FIG. 3 shows a diagram of a progression of a tangential and of a radial directional component of a magnetic field of the hollow shaft shown in FIG. 1 in unloaded state;

FIG. 4 shows a diagram of a progression of an axial, of a tangential and of a radial directional component of magnetic fields of the hollow shaft shown in FIG. 1.

### DETAILED DESCRIPTION

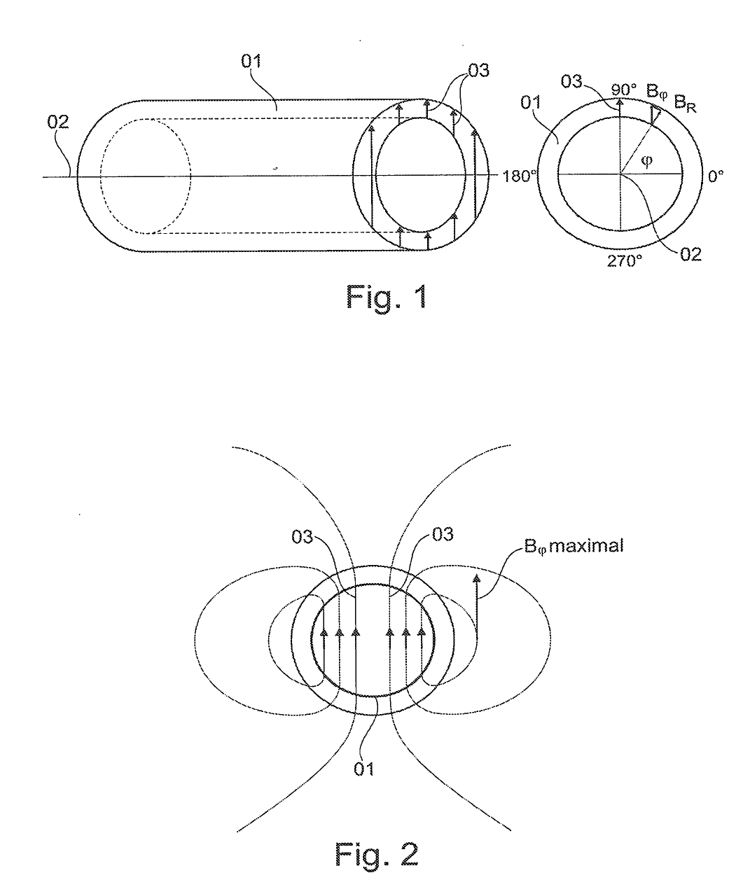

FIG. 1 shows a machine element in the form of a hollow shaft 01, which forms a part of a first embodiment. The hollow shaft 01 is shown in a perspective view from the front and in a cross-sectional view. The hollow shaft 01 has an axis 02, in which the hollow shaft 01 extends. The axis 02 also forms an axis of symmetry of the hollow shaft 01.

The hollow shaft 01 has a diametrical permanent magnetization 03, which is illustrated by directional arrows. The directional arrows of the permanent magnetization 03 run parallel to one another in the hollow shaft 01 and vertically to the axis 02. The directional arrows of the permanent magnetization 03 run parallel to a diameter of the hollow shaft 01, which intersects the axis 02 at a right angle and runs vertically in the exemplary representation.

The diametrical permanent magnetization 03 leads to a place which is to be assigned a rotational angle φ, to a magnetic field, which has a tangential directional component B_{φ} of the magnetic flux density and a radial directional component B_{R} of the magnetic flux density.

The arrangement further comprises a multiple axis magnetic field sensor (not shown) for measurement of a radial directional component, of a tangential directional component and of an axial directional component of magnetic fields which emerge from the hollow shaft 01.

FIG. 2 shows the magnetic field lines within and outside of the hollow shaft 01 brought about by the permanent magnetization 03 in the case of the hollow shaft 01 shown in FIG. 1. The field lines of the diametrical permanent magnetization 03 close outside of the hollow shaft 01. In the case of a rotational angle of 0° in relation to the coordinate system shown in FIG. 1 a maximum B_{φmaximal} of the tangential directional component of the magnetic Flux density occurs, in the case of a rotational angle of 90° a minimum of the tangential directional component occurs.

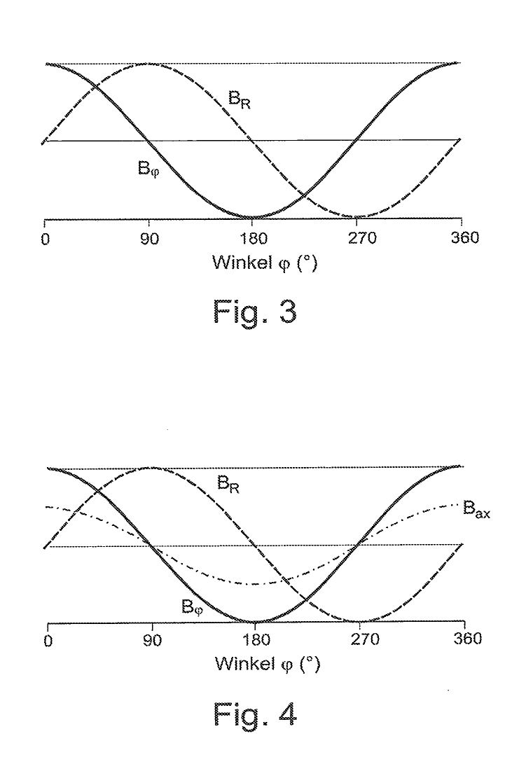

FIG. 3 shows a diagram of a progression of the tangential directional component B_{φ} of the magnetic flux density and of the radial directional component B_{R} of the magnetic flux density of the permanent magnetization 03 shown in FIG. 1 dependent on the rotational angle φ. The amplitude progressions of these two directional components are phase shifted by 90°. These two directional components are measured with the multiple axis magnetic field sensor in order to measure the rotational angle φ of the hollow shaft 01 (shown in FIG. 1). In the case of the shown progression, the hollow shaft 01 is not stressed by a torsion, so that no further directional component of a magnetic field occurs.

FIG. 4 shows a diagram of a progression of the tangential directional component B_{φ} of the magnetic flux density and of the radial directional component B_{R} of the magnetic flux density of the permanent magnetization 03 shown in FIG. 1. The diagram further shows a progression of a magnetic flux density which is brought about by a torsional moment acting on the hollow shaft 01 and by the permanent magnetization 03 and which has an axial directional component Bₐₓ. By measurement of the amplitude and/or phase location of the axial directional component Bₐₓ the torsional moment acting on the hollow shaft 0.

### REFERENCE LIST

01 Hollow shaft
02 Axis
03 Permanent magnetization
φ Rotational angle
B_{φ}tangential directional component
B_{R} radial directional component
Bₐₓ axial directional component

1. An apparatus for contactless measurement of a torque on a machine element, comprising:
a machine element that has a permanent magnetization at least within an axial section of the machine element and oriented parallel to a radially oriented straight line; and
at least one magnetic field sensor configured to measure:
an axial directional component of a magnetic field from the permanent magnetization and the torque; or
a change of the axial directional component of the magnetic field from the permanent magnetization and the torque.

2. The apparatus of claim 1, wherein the permanent magnetization includes two poles that are arranged to lie diametrically opposite one another in relation to the axis.

3. The apparatus of claim 1, wherein magnetic field lines of the permanent magnetization run parallel to one another and perpendicular to the axis.

4. The apparatus of claim 1, wherein the sensor is further configured to measure:
(1) a rotational angle and a rotational speed of the machine, element; and
(2) a rotational angle-dependent change of the magnetic field of the permanent magnetization.

5. The apparatus of claim 1, wherein the magnetic field sensor is configured to measure two directional components of magnetic field of the permanent magnetization oriented perpendicular to one another.

6. The apparatus of claim 1, wherein the magnetic field sensor is further configured to measure:
(1) a radial directional component of the magnetic field of the permanent magnetization; and
(2) a tangential directional component of the magnetic field of the permanent magnetization.

7. The apparatus of claim 1, wherein the machine element is formed by at least one of a shaft, flange, hollow shaft, or hollow flange.

8. (canceled)

9. (canceled)

10. (canceled)

11. An apparatus for contactless measurement of torque, comprising:
a machine element that includes a magnetization section located at least within an axial section of the machine element; and
one or more magnetic field sensors configured to measure an axial directional component of a magnetic field resulting from:
(1) the magnetization; and
(2) a torque on the machine element.

12. The apparatus of claim 11, wherein the one or more magnetic field sensors are configured to measure a rotational angle of the machine element.

13. The apparatus of claim 11, wherein the one or more magnetic field sensors are configured to measure a rotational speed of the machine element.

14. The apparatus of claim 11, wherein the magnetization section is permanently magnetized and includes two magnetic poles diametrically opposite one another in relation to an axis of the machine element.

15. The apparatus of claim 11, wherein the magnetization section is oriented parallel to a straight line oriented radially in relation to an axis of the machine element.

16. The apparatus of claim 11, wherein the machine element includes a ferromagnetic material in the axial section.

17. The apparatus of claim 11, wherein the one or more magnetic field sensors are further configured to measure an amplitude of the axial directional component of the magnetic field.

18. The apparatus of claim 11, wherein the one or more magnetic field sensors are further configured to measure different directional components of the magnetic field.

19. The apparatus of claim 18, wherein the machine element includes a hollow shaft.

20. The apparatus of claim 11, wherein the one or more magnetic field sensors are configured to measure a rotational angle-dependent change of the magnetic field.

21. A method for contactless measurement of torque comprising:
magnetizing a section of a machine element, wherein the section is located within an axial section of the machine element and oriented parallel to a radially oriented straight line;
measuring, utilizing a magnetic field sensor, an amplitude of an axial directional component of a magnetic field in response to the magnetizing of the section; and
measuring, utilizing the magnetic field sensor, the axial directional component of the magnetic field in response to a change of the magnetic field due to a torque on the machine element.
